(19) United States
(12) Patent Application Publication
(10) Pub. No.: US 2016/0131388 A1
(43) Pub. Date: May 12, 2016

(54) CONTEXTUAL SCORING IN A BUILDING AUTOMATION SYSTEM

(71) Applicant: Trane International Inc., Davidson, NC (US)

(72) Inventors: Benedict John Eiynk, North Branch, MN (US); Mitchel James Anderson, Hugo, MN (US)

(73) Assignee: Trane International Inc., Davidson, NC (US)

(21) Appl. No.: 14/938,877

(22) Filed: Nov. 12, 2015

Related U.S. Application Data
(60) Provisional application No. 62/078,548, filed on Nov. 12, 2014.
(60) Provisional application No. 62/078,599, filed on Nov. 12, 2014.

(51) Int. Cl. F24F 11/00; G06F 17/30

(52) U.S. Cl. CPC F24F 11/0086; G06F 17/30991

(57) ABSTRACT

A method and system for providing actionable options, particularly reporting options, to a user of a building automation system via a user interface (UI) based on a current context of the user includes the system identifying contextual information associated with the UI in a building automation system. A list of predefined (reporting) options is then ranked based on a relevance of each of the predefined options to the contextual information. The ranked list is then presented to the UI. Ranking is achieved by assigning a relevance score to each of the predefined options based on the relevance of metadata associated with the predefined options to the contextual information associated with the UI. The contextual information includes source data from components and devices of the system associated with the user interface. A computer-readable device to store instructions executable by a processor to perform the operations described herein is also provided.

### CROSS-REFERENCE TO RELATED APPLICATIONS

This application claims the benefit of and priority to U.S. Provisional Application Ser. No. 62/078,548 entitled “CONTEXTUAL SCORING IN A BUILDING AUTOMATION SYSTEM” filed Nov. 12, 2014, and U.S. Provisional Application Ser. No. 62/078,599 entitled “CONTEXTUAL INDEXING IN A BUILDING AUTOMATION SYSTEM” filed Nov. 12, 2014, the entirety of each of which is hereby incorporated by reference herein for all purposes.

### BACKGROUND

1. Technical Field

The present disclosure relates generally to building automation systems. More specifically, this disclosure relates to prioritizing actionable options presented to a user of a building automation system based on current context.

2. Background

A building automation system coordinates, manages, and automates control of any number and type of environmental, lighting, and other subsystems necessary to operate a building. For example, a known building automation system configured to control heating, ventilation, and air conditioning components (referred to as an “HVAC” system), uses a centralized server and open-standard protocols, such as BACnet/IP, to communicate with and integrate the various components within the system.

Building automation systems also provide functionality to users to manage various aspects of the HVAC system, through reporting features and other actionable options provided through user interfaces. Information can be presented in the form of detailed equipment and system status reports or user interfaces, alarm management options, and additional reports or user interfaces for monitoring data trending, for scheduling and for performing data analysis. A user can typically access this functionality either locally via a computer hard-wired or wirelessly connected to the HVAC system, or remotely via a computer or mobile device. A variety of additional user interfaces can be provided for obtaining information and taking actions necessary to manage the building(s) being monitored, and may be standard “out of the box” interfaces or customized interfaces. For example, customized user interfaces may include custom artwork to represent the particular building(s) and other aspects within a user's HVAC system, and to consolidate information that is unique to the particular environment and usage.

While known building automation systems are configured for scalability and a certain amount of flexibility, there is a continuing need to optimally and efficiently manage, organize, and display the large amounts and types of data available within a building, or across multiple buildings that may be managed as a single enterprise.

### SUMMARY

The present disclosure is directed to a method and system for prioritizing actionable options presented to a user of a building automation system based on a current context in which the user is accessing or managing the building automation system.

In one aspect, the present disclosure provides a method for providing actionable options to a user of a building control system via a user interface based on a current context. The building control system identifies contextual information associated with a context in which a user is accessing the building control system from a user interface. The method includes ranking a list of predefined reporting options based on a relevance of each of the predefined reporting options to the contextual information. The ranked list of predefined reporting options is then presented to the user interface.

In embodiments, the ranked list is presented in a pop-up window on the user interface. In some embodiments, the ranked list is presented in response to user selection of actionable content on the user interface.

The predefined reporting options may be stored in a database associated with the building control system and, in some embodiments, the predefined reporting options include either customized reporting options defined by a user or standard reporting options provided by the building control system, or a combination of both.

The contextual information may include one or more of a floor, a space, a building, a system, a piece of equipment, a sensor, a status, a system property, a current system condition, and a user attribute associated with a user accessing the user interface.

In embodiments of the method, a predefined reporting option is scored based on a correlation between the contextual information and information included in the corresponding predefined reporting option. A relevance score is assigned based on the correlation. Each of the predefined reporting options is similarly scored and assigned a corresponding relevance score. The list of predefined reporting options is then ranked in accordance with the relevance scores from a highest to lowest relevance score.

Each predefined reporting option may be associated with at least one system property. In embodiments, scoring includes calculating the relevance score for each of the predefined reporting options as a percentage of the system properties included in the predefined reporting option that match the contextual information.

The method in accordance with embodiments further includes identifying a current system condition of the building control system. The relevance score for each of the predefined reporting options that includes information associated with the current system condition is then weighted by a predetermined weighting factor. For example, the current system condition may include an alarm, a key performance indicator, a predetermined day, and a predetermined range of time. In this way, the relevance or importance of reporting options pertaining to the presence of such system conditions is increased relative to other common contextual factors.

In some embodiments, the relevance score for each of the predefined reporting options is weighted, by a predetermined weighting factor, based on attributes associated with a user accessing the user interface.

In another aspect, the present disclosure provides a computer-readable device. The computer-readable device stores instructions that, when executed by a processing device, cause the processing device to perform operations, including identifying contextual information associated with a user interface in a building control system. The operations also include ranking a list of predefined reporting options based on a relevance of each of the predefined reporting options to the contextual information; and presenting the ranked list of predefined reporting options to the user interface.

The operation of ranking the list of predefined reporting options may further include scoring one of the predefined reporting options based on a correlation between the contextual information and information included in the corresponding predefined reporting option. A relevance score is then assigned to each of the predefined reporting options based on the scoring, and the list of predefined reporting options is ranked in accordance with the relevance score from a highest to lowest relevance score.

The operations may further include identifying a current system condition of the building control system, and weighting, by a predetermined weighting factor, the relevance score for each of the predefined reporting options that includes information associated with the current system condition. In various embodiments, the operations further include weighting, by another predetermined weighting factor, the relevance score for each of the predefined reporting options based on attributes associated with a user accessing the user interface. The predetermined weighting factors used for the different system conditions and for user attributes may or may not be the same factor.

The contextual information may include one or more of a floor, a space, a building, a system, a piece of equipment, a sensor, a status, a system property, a current system condition, and a user attribute associated with a user accessing the user interface.

In another aspect, the present disclosure provides a building automation system comprising a server and a plurality of control devices operably connected to the server. The server is communicatively coupled to a user device, which is configured to display a user interface generated by the server. The server is further configured to identify contextual information associated with the user interface in the building automation system, rank a list of predefined reporting options based on a relevance of each of the predefined reporting options to the contextual information; and present the ranked list of predefined reporting options to the user interface.

In embodiments of the system, the server is further configured to receive data, which includes data attributes associated therewith, from the plurality of control devices. The data are used to generate the user interface with the contextual information.

The server may be further configured in embodiments of the system to score one of the predefined reporting options based on a correlation between the contextual information and information included in the corresponding predefined reporting option. A relevance score is then assigned to each of the predefined reporting options based on the scoring; and the list of predefined reporting options is ranked, by the server, in accordance with the relevance score from a highest to lowest relevance score.

In embodiments, the server is further configured to identify a current system condition of the building control system, and to weight, by a predetermined weighting factor, the relevance score for each of the predefined reporting options that includes information associated with the current system condition.

In further embodiments, the building automation system further includes a database. The server is further configured to store the predefined reporting options, and, optionally, additional information including tags, report identifiers, and/or metadata associated therewith, in the database and to retrieve the predefined reporting options from the database for presenting the ranked list to the user interface.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure.

FIG. 1 is a schematic diagram of an embodiment of a building automation system formed in accordance with the present disclosure;

FIG. 2 is a block diagram representation of data flow in an embodiment of a building automation system formed in accordance with the present disclosure;

FIG. 3A is a block diagram representation of an embodiment of a method formed in accordance with the present disclosure;

FIG. 3B is a block diagram representation of another embodiment of a method formed in accordance with the present disclosure;

FIG. 3C is a block diagram representation of yet another embodiment of a method formed in accordance with the present disclosure; and

FIGS. 4-9 are pictorial representations of user interfaces formed in accordance with embodiments of a building automation system of the present disclosure.

The various aspects of the present disclosure mentioned above are described in further detail with reference to the aforementioned figures and the following detailed description of exemplary embodiments.

### DETAILED DESCRIPTION

The present disclosure is directed to a method and system for prioritizing actionable options, particularly, reporting options, presented to a user of a building automation system for controlling heating, ventilation, and air conditioning (“HVAC”) equipment, based on a current context in which the user is accessing or managing the building automation system.

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure is described herein in terms of functional block components, optional selections, page displays, and various processing steps. It should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed by any device, on a variety of operating systems, including without limitation Apple OSX®, Apple iOS®, Google Android®, HP WebOS®, Linux, UNIX®, Microsoft Windows®, and/or Microsoft Windows Mobile®.

It should be appreciated that the particular implementations described herein are illustrative of the disclosure and its best mode and are not intended to otherwise limit the scope of the present disclosure in any way. Examples are presented herein which may include sample data items which are intended as examples and are not to be construed as limiting. Indeed, for the sake of brevity, conventional data networking, application development and other functional aspects of the systems (and components of the individual operating components of the systems) may not be described in detail herein. It should be noted that many alternative or additional functional relationships or physical or virtual connections may be present in a practical electronic system or apparatus. In the discussion contained herein, the terms user interface element and/or button are understood to be non-limiting, and include other user interface elements such as, without limitation, a hyperlink, clickable image, and the like.

As will be appreciated by one of ordinary skill in the art, the present disclosure may be embodied as a method, a data processing system, a device for data processing, and/or a computer program product. Accordingly, the present disclosure may take the form of an entirely hardware embodiment, an entirely software embodiment, or an embodiment combining aspects of both hardware and software. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the present disclosure may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like. The steps recited herein may be executed in any order and are not limited to the order presented. Moreover, two or more steps or actions recited herein may be conducted concurrently.

The disclosed systems and/or methods may be embodied, at least in part, in application software that may be downloaded, in whole or in part, from either a public or private website or an application store (“app store”) to a mobile device. In another embodiment, the disclosed system and method may be included in the mobile device firmware, hardware, and/or software. In another embodiment, the disclosed systems and/or methods may be embodied, at least in part, in application software executing within a webserver to provide a web-based interface to the described functionality.

In yet other embodiments, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein.

An “actionable option” refers to a user-selectable option or content to execute a particular action, or set of instructions. When the actionable option is selected by the user, the selected option is executed. In particular, an “actionable reporting option,” also referred to as “reporting option,” as used herein, is a user-selectable option displayed on a user interface to generate a particular report.

“Actionable content” is similarly used herein to refer to content, which may be text or a graphical element, that when selected, causes an action to be executed.

In the present disclosure, actionable reporting options may be presented on a user interface, for example, as a listing in a pull-down menu, or in a pop-up window or frame on the user interface. The actionable reporting options may be presented in response to user selection of actionable content. For example, as described further herein, the user interface may include actionable content such as “run a report.” User-selection of this actionable content, in some embodiments, presents a ranked listing of relevant reporting options for selection by the user.

Although the particular embodiments described herein are directed to prioritizing actionable reporting options based on context, other types of actionable options can also be prioritized based on context in accordance with the present disclosure. For example, another example of an “actionable option” is a particular user interface, or page. In conventional applications, a user navigates to a page by selecting the page from a navigation tree. Selection of the particular page displays the user interface on a user device. In accordance with embodiments of the present disclosure, the pages are prioritized for selection by the user based on context.

“Context” refers generally to a context within an HVAC system in which a user is accessing or viewing current information associated with the HVAC system, typically using a user interface generated by the system.

“Contextual information,” as used herein, also referred to as “context information,” refers to information related to the context, and may include any of the source data, including data attributes or metadata, associated with components of the HVAC system that are displayed on a user interface, and properties associated therewith. As described further herein, the contextual information can include, but is not limited to, a particular building; a floor, space, and/or room within a building; identification of and/or measurements, modes, or properties associated with particular components, systems, devices, sensors, or equipment, and so on. Contextual information may additionally, or alternatively, include a status, a system property, a current system condition, state parameters, and user attributes associated with or coincident with the user accessing or viewing the user interface.

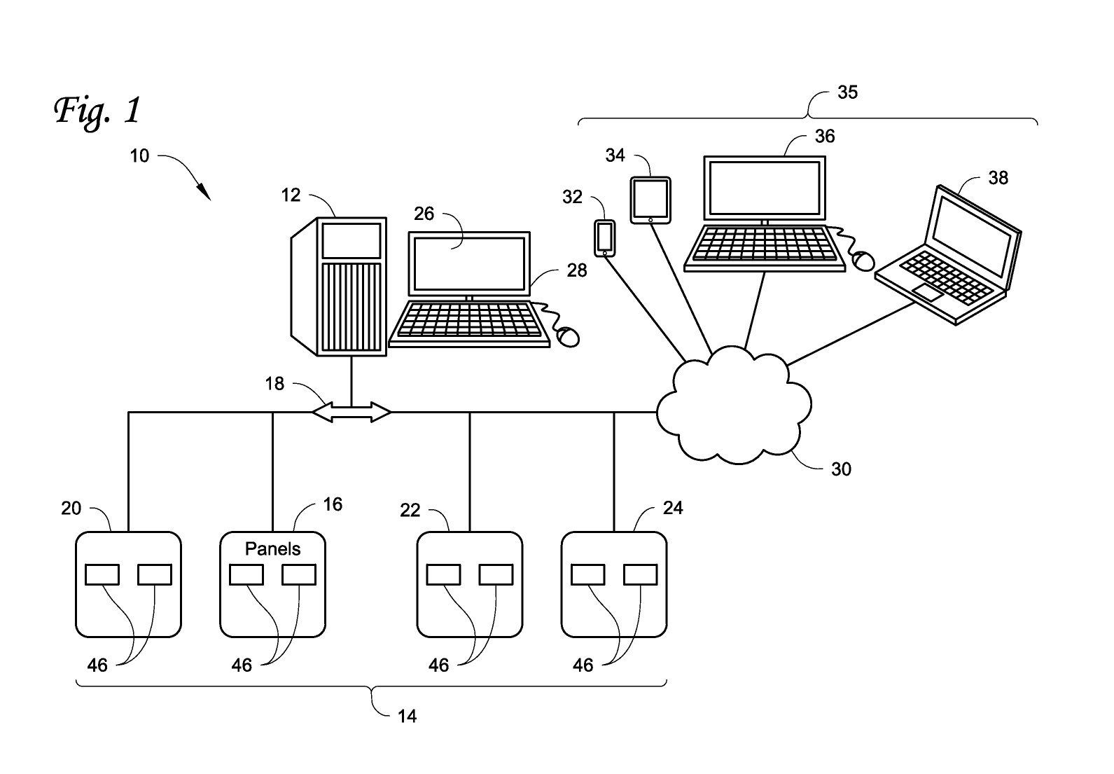

Referring to FIG. 1, an embodiment of a building automation system 10 in accordance with the present disclosure includes a centralized server 12 that is specially configured to execute the methods of the present disclosure. In the embodiment of FIG. 1, the server 12 is further configured to establish communications with and control one or more heating, ventilation, and air conditioning components 14 within one or more buildings. The control components 14 may be devices, systems or sub-systems, or units, which are integrated into the system 10.

Control components 14 may include a system or building controller 16, which may be operable via a touch-screen panel or computer workstation, operably coupled to the server 12 and to the other devices within the system 10 over a network 18. Components 14 may also include one or more of control units 20, third-party control units 22, and other devices or components 24 of an HVAC management system.

Each of these components 14 is operably coupled within the network to the server 12. In some embodiments, the server 12 may be locally networked at a building location in which at least some of the components 14 reside. The server 12 may be communicatively coupled with the components 14 using, for example, any combination of one or more of a Local Area Network (LAN), the Internet, Intranet, WAN, wireless communication network, and any other means known in the art suitable for operably and communicatively coupling the server 12 and one or more components 14.

A user may access and interact with the system 10 through any graphical user interface (GUI) presented on a graphical display 26 associated with a suitable device. Suitable graphical displays 26 may be operably coupled to the server 12, by any means known in the art, and may be provided, for example, by a desktop computer 28 locally networked with the server 12. In various embodiments, user access to the system 10 is provided by any suitable device 35, including, but not limited to, a mobile device, such as a mobile phone 32 or a tablet 34, a personal desktop computer 36, or a portable laptop 38. Such devices may be enabled for remote access over any appropriate network(s) 30, which may include, without limitation, the Internet, an Intranet, any suitable local or wide area communication network, a GPS-enabled network, WiFi, Bluetooth, or any wireless cellular communication network.

Examples of the components 14 which may be included in various embodiments of the building automation system in accordance with the present disclosure include, but are not limited to, systems, monitors and controllers such as: furnaces and heating systems; air conditioners, filters, air purifiers; ventilation systems; chillers; safety (such as fire) systems; security systems; electrical and lighting system monitors and controllers; ventilation system monitors and controllers; sensors, including, without limitation, occupancy, smoke, light, motion, humidity, and others; pumps; air handlers; fluid and air moving and handling equipment; medical and pharmacological control equipment and monitoring systems; clean rooms; industrial automation and control equipment and systems; programmable logic controllers; and so on.

Each of the components 14 may also be composed of any number of additional devices or sources of data 46 within the building automation system 10. These devices 46, which may also include but are not limited to, binary and analog devices, controllers (providing both input and output data points), sensors, control units and the like for measuring, and/or communicating data associated with the HVAC management 10.

It should be appreciated that the source data from the various devices 46 within the system 10, provide information related to various properties of the space or building in which the device is located, such as occupancy, mode (such as heat/cool), space temperature set point, air flow, efficiency, and any number of additional properties associated with at least a point, device, space, system, or subsystem of a building, or portion (e.g., floor) of a building or collection of buildings.

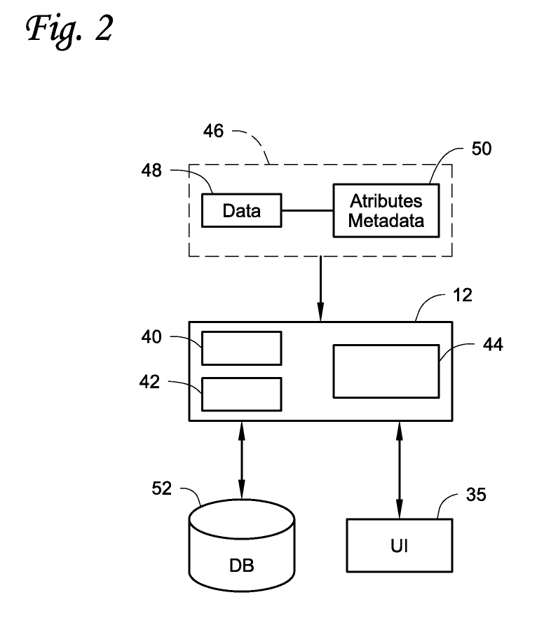

The flow of data related to the various components 14 and devices 46 within an embodiment of the building automation system 10 is illustrated in FIG. 2. Data 48 generated by the devices 46, and relevant attributes and/or metadata 50 associated therewith (collectively referred to herein as “source data”), are received by the server 12 and may be stored in a database 52.

While the metadata 50 provides static context in which the data is generated, it also provides current context in regard to a user who is accessing the information provided on the user interface. For example, the metadata 50 is associated with characteristics of the source (the type of sensor and location) that do not change, such as a location attribute associating the source of the data 46 with a particular building, as well as to the particular location (building, floor, space, system, device, data point) within the building, and a type attribute (type of equipment, such as air valve; or type of sensor, such as temperature sensor). The metadata 50 can be used to determine what types of information are relevant to the user accessing the user interface. The data 48 from a source, which may, for example, indicate a current property, state, measurement, or mode (such as “occupied” or “not occupied” from an occupancy sensor; or a continually updated data point such as a temperature from a temperature sensor), represents a current state of the source and may change over time. Accordingly, contextual information used to prioritize actionable items in accordance with embodiments of the present disclosure may include both the data 48 and metadata 50 associated with the user interface, which includes, inter alia, identification of any components, and/or devices displayed, their location within the building, and one of more of a property, state, measurement, or mode associated therewith.

Referring still to FIG. 2, in accordance with embodiments of the present disclosure, relevant source data is used to generate user interfaces 35 viewable on a graphics display of any suitable user device. The user interfaces 35 may be generated from standard templates provided by the system and may also be generated from customized or user-defined templates to generate user interfaces 35 based on current contextual information including relevant source data retrieved from the devices 46. Both standard and customized templates for generating the user interfaces can be stored on, and retrieved from a database 52 in various embodiments of the present disclosure. Additionally, as described further herein, different types of information are provided based on the particular user interface invoked for viewing by the user. Accordingly, contextual information will include the particular source data that are associated with the particular user interface generated for display on a user's device.

Referring still to FIG. 2, in one embodiment, the centralized server 12 includes at least a processing device or devices 40, memory including computer readable memory or storage 42 for storage of software, instructions, or executable code, which when executed by the processing device(s) 40 causes the processing device(s) 40 to perform methods or method steps of the present disclosure, which may be embodied at least in part in programming instructions 44 stored on or retrievable by the server 12. It will be appreciated by those of ordinary skill in the art that such components and programming instructions for performing the methods or method steps of the present disclosure may also be distributed among various devices, including user devices such as mobile devices, phones, tablets, and so on according to various means known in the art.

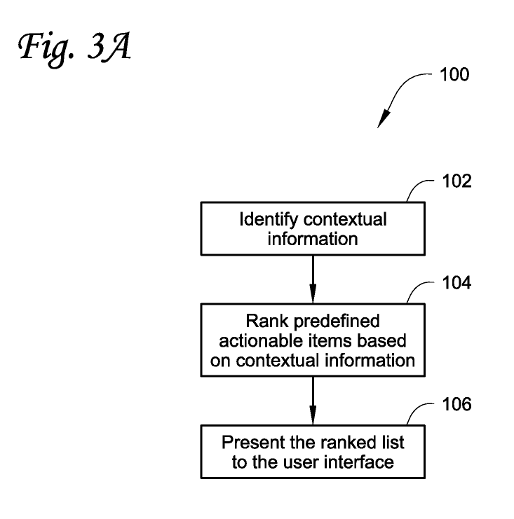

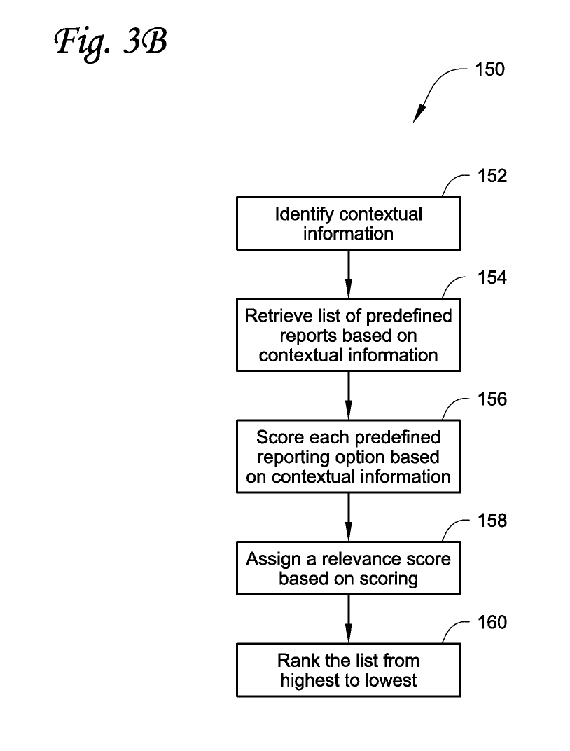

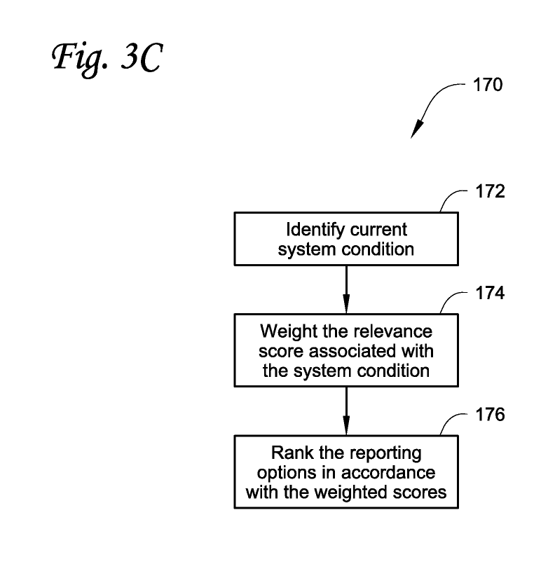

FIG. 3A illustrates an embodiment of a method of the present disclosure to provide actionable options to a user of a building automation system based on a current context of a user accessing the building automation system. The user may, in certain embodiments, be a manager of the system, such as the building automation system represented in FIG. 1.

In accordance with the method 100, the system identifies, at 102, contextual information associated with a user interface in the building automation system. The user interface may be provided or generated by the building automation system. At 104, a list of predefined actionable options is ranked based on the contextual information. The predefined actionable options may be stored in a database, such as database 52 in the embodiment of a system shown in FIG. 2. Accordingly, in embodiments of methods in accordance with the present disclosure, the predefined actionable options may be retrieved for ranking at 104 from a database associated with the system.

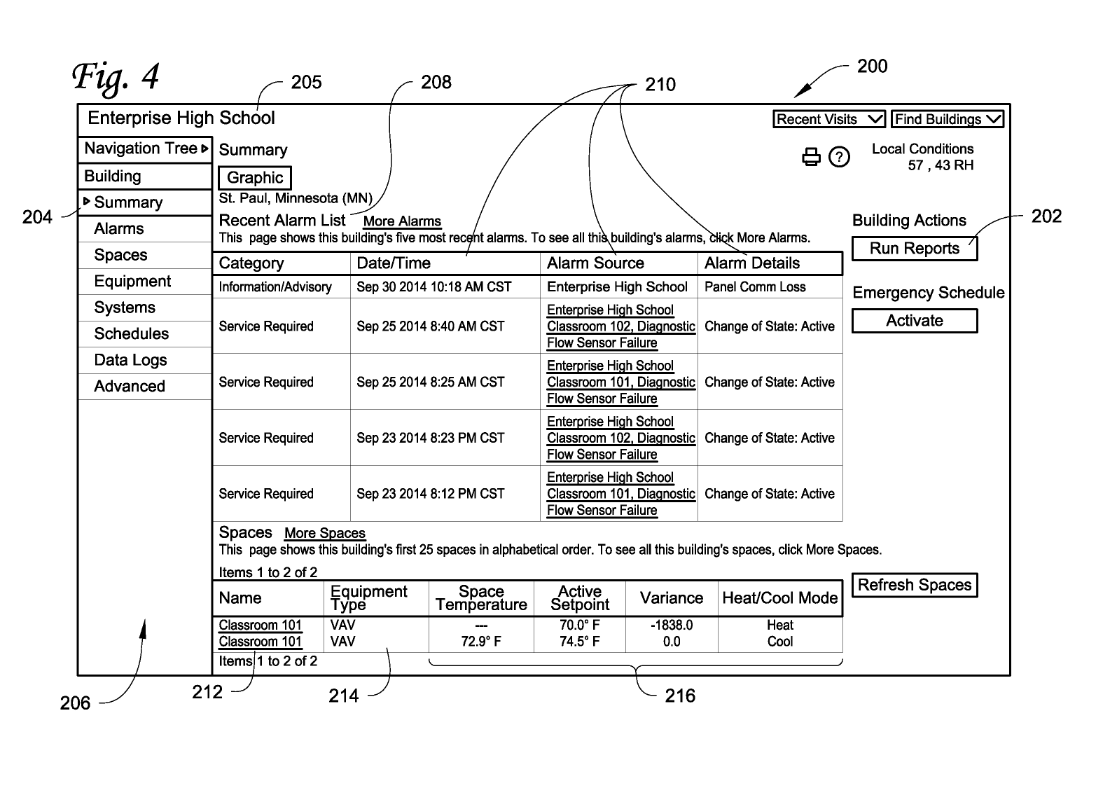

Still referring to FIG. 3A, at 106, the ranked list from 104 is then presented to the user interface. In particular embodiments, the actionable options are actionable reporting options, and the predefined actionable options are predefined reporting options. According to embodiments, each of the reporting options, or reports, includes metadata and/or other information, for example, related to a system property or condition. For example, with reference to FIGS. 4-9, such system properties can include, but are not limited to, an occupancy status, a heat/cool mode, a space temperature set point, a space temperature measurement, or an air flow condition. Accordingly, the information included in a report can be compared to contextual information. To assist in determining a relevance of a reporting option to contextual information, each reporting option may also be associated with other metadata, tags, or report identifiers that can be used to determine a relevance of the report to the contextual information. These other metadata, tags, or report identifiers may be stored along with the reports in the database associated with the building automation system.

It will be appreciated by those of skill in the art that there are numerous system properties, as well as diagnostic (system or equipment) conditions, that can comprise the contextual information associated with a user interface of a building automation system in accordance with the present disclosure. Some of these system properties, which may be associated with any of the components 14 or devices 46 of an HVAC system as described herein, for example, are listed below. The lists are provided as examples only, and are not intended to limit the various system properties which might comprise contextual information in accordance with the present disclosure. Further, the following lists are provided under topical headings which may, in some embodiments, generally represent the particular user interface which may include one or more of the system properties associated with that heading. For example, a user interface describing a particular “space” may include one or more of the system properties that are listed below to describe the particular space, and so on. The following examples of system properties are provided under the headings: space, chiller, air handler, area, air system, and chiller plant.

Space
Occupancy Status
Heat/Cool Mode
Air Valve Position
Air Flow
Space Temperature Setpoints
Space Temperature
Space CO2
Discharge Air Setpoints
Heating/cooling capacities
Outdoor Air Conditions
Outdoor Air Setpoints
Economizing Status

Chiller
Operating Mode
Operating Limit Setpoints
Chilled Water Setpoints
Flow Setpoints
Running Capacity Setpoints and Status
Current Limit Setpoints
Condenser Status
Evaporator Status
Compressor Status

Air Handler
Occupancy Status
Heat/Cool Mode
Heating/cooling capacities
Discharge Air Setpoints
Air Compressor Status
Fan Status
Outdoor Air Conditions
Outdoor Air Setpoints
Economizing Status

Area
Occupancy Status
Space Temperature Setpoints
Space Temperature
Heat/Cool Mode
Space Humidity
Outdoor Air Conditions
Outdoor Air Setpoints
Economizing Status

Air System
Occupancy Status
Operating Mode
Duct Static Pressure
Duct Static Setpoints
Ventilation Optimization Flow Setpoints

Chiller Plant
Chiller Water Setpoints
Pump Status
Flow Status
Current Limit Setpoints
Running Capacity

In some embodiments, the predefined reporting options can include customized reporting options defined by a user, or standard reporting options provided by the building automation system, or a combination of both.

In accordance with embodiments, the list of predefined reporting options retrieved from the database for ranking may be a list of reports that have been identified as matching any of the contextual information associated with the user interface. For example, as disclosed in the Related Application, the entirety of which is incorporated herein by reference thereto, a list of matching, or related reports can be identified from report identifiers that match contextual information from a user request. Such user requests may include information associated with the user interface from which the request is made.

Referring to FIG. 3B, in another embodiment 150 of a method in accordance with the present disclosure, the system identifies, at 152, contextual information associated with a user interface in the building automation system. The user interface may be provided or generated by the building automation system. At 154, a list of predefined reporting options is retrieved, for example, from the database, based on the contextual information. The list of predefined reporting options is then ranked based on the contextual information. In the embodiment represented in FIG. 3B, at 156, for each predefined reporting option, the system calculates a score based on a correlation between the contextual information and information included in the corresponding predefined reporting option, as described further below, for example. Each of the predefined reporting options is scored accordingly and assigned a relevance score at 158. The system then ranks the list of predefined reporting options at 160 in accordance with the relevance score for presentation to the user interface, preferably in an order from a highest to lowest relevance score.

Referring to FIG. 3C, in another embodiment of a method 170 of the present disclosure, current system conditions or other factors, such as the attributes of a user accessing the system, may be used to weight the relevance scores calculated, for example, at 156 of the embodiment shown in FIG. 3B. At 172, the system identifies a current system condition. Such system conditions may include, but are not limited to, an alarm, diagnostic conditions such as a system or an equipment diagnostic, a key performance indicator (“KPI”), a predetermined day, and/or a predetermined range of time during the day.

For example, while an existing alarm condition may not be apparent from the user interface the user is currently accessing, the system can alert the user to the alarm condition, and/or can use the alarm condition to increase the relevance score of any reports relevant to the particular alarm. For example, if an alarm is present for a high space temperature, the relevance score for each report that includes space temperature data is weighted, at 174, by a predetermined weighting factor. The reporting options are then ranked, at 176, in accordance with the weighted relevance scores.

In addition to weighting the reports in the event of an alarm condition, key performance indicators (KPIs) can also be used to weight the scoring. A key performance indicator could be any condition defined for a particular data source property, and can include indicators of effectiveness or building performance. Because KPIs, like alarm conditions, are important to the operation and management of a building automation system, in some embodiments, the presence of a KPI associated with a property or system parameter is used to inflate or decrease the scoring of reporting options including such properties.

There may be other circumstances in which a reporting option that conveys information based on the day or a range of time for a particular day is particularly relevant to a user. Accordingly, the day or range of time can also be used to weight the relevance scores of corresponding reporting options associated therewith. For example, in some circumstances, it may be desirable to score a report that provides occupancy information higher in the evening, after typical daytime hours, than during the day.

In other embodiments, the relevance score for each of the predefined reporting options may be weighted by a predetermined weighting factor based on attributes associated with a user accessing the user interface, or on who the report is being generated for (or sent to). Such attributes may include a user's identity, different privileges, a user's position within an organization, a location within a building, and so on.

In some embodiments, any one or more of these or other system conditions and/or user attributes may be included in the contextual information used to determine relevance scores, without weighting.

As discussed in further detail below in reference to FIGS. 4-9, contextual information can be provided in many forms by various user interfaces, and in many different levels of detail. Summary information may be provided by some user interfaces while detailed information can be provided by other user interfaces for any feature or location of the building. In some embodiments, user interfaces may be available that are not tied to particular location or equipment information. For example, a summary page of “All Reports” that are available to the user may be provided by a particular user interface. In these embodiments, the contextual information on which the correlation scores are based can include one or more user attributes, the day and time the user is accessing the system, and/or any current system condition including, but not limited to, existing alarms and KPIs.

Referring to FIG. 4, one embodiment of a user interface 200 generated by the system includes, inter alia, actionable content 202 to “Run Reports.” When this content 202 is selected by the user, a user request is generated. In response to receiving the user request, a list of predefined reporting options, which may, for example, be a list of matching reports identified in accordance with the methods disclosed in the Related Application, are ranked by the system for presentation to the user interface. The ranked list may be presented in a pop-up window, pull-down menu (not shown), or any other appropriate form on the interface 200.

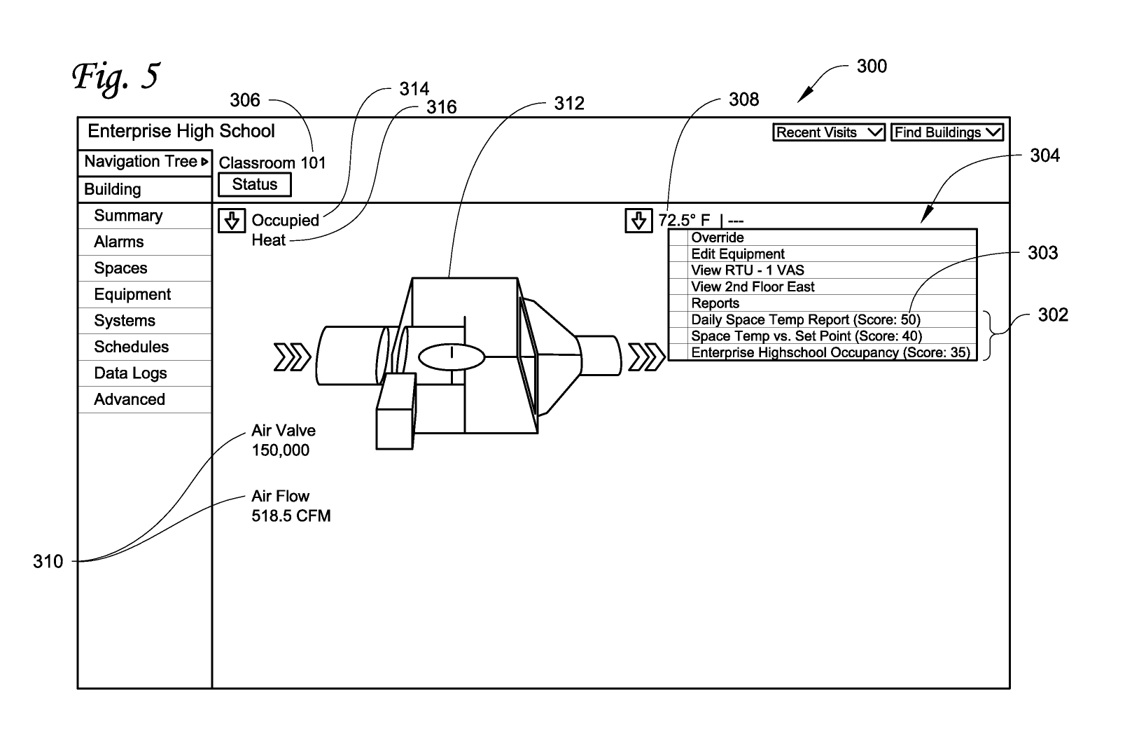

As shown in another embodiment of a user interface 300, referring to FIG. 5, the ranked list 302 may be presented in a pop-up window 304 generated, in some embodiments, contemporaneously with the generation of the user interface 300 by the system. In FIG. 5, the ranked list of reports may also indicate a relevance score 303 calculated for each report.

Contextual information used to score the predefined reporting options in some embodiments includes at least a location, which may include identification of a particular floor, space, and/or building. The contextual information may also include a particular system, piece of equipment, sensor, status, and/or properties associated with the location. Referring still to FIG. 5, the user interface 300, provides a context in which a user is accessing the system, which in this case, includes a particular device, a variable air volume unit controlling a particular space.

Any of this contextual information may be displayed on, or otherwise associated with, the user interface. The scoring step then includes calculating the relevance score for each predefined reporting option as a percentage of, for example, the properties included in the report that match the properties or information indicated on the user interface. For example, such properties may include one of an occupancy status, a heat/cool mode, a space temperature set point, a space temperature, and an air flow.

In some embodiments, the relevance score may be calculated as a percentage of any properties, data, and/or metadata included in the report, and/or associated with the report (stored as identifiers, or metadata, or tags, for example) that match the contextual information associated with the user interface.

As illustrated further by FIG. 5, the user interface 300 provides contextual information for a particular space or room (“Classroom 101”) 306 within a building. The contextual information includes data such as a space set temperature 308 and air flow measurements 310 associated with a particular piece of equipment, an air valve 312, located in the space. The contextual information also includes additional properties or modes provided by sensors or devices associated with the space. In particular, an occupancy sensor indicates that the space is occupied 314, and is being heated 316. Predefined reporting options are ranked based on this contextual information in accordance with embodiments of the present disclosure. For example, based on the context related to user interface 300, the most relevant reporting options are shown in ranked order 302 from most to least relevant as a Daily Space Temperature Report, a Space Temperature vs Set Point Report, and an Occupancy Report.

FIG. 4 and FIG. 5 represent two different types of user interfaces that may be generated in a building automation system in accordance with the present disclosure. FIG. 4 represents a standard interface that is easily portable to any building automation system, whereas FIG. 5 represents a customized interface that includes specific relevant information in the form of graphical displays that may replace left-side navigation trees 206. In the standard interface, users typically navigate to a particular floor, space, device and so on using a navigation tree 206. In the customized interface, the user can navigate by clicking on graphical elements. For example, a user may select a particular space, shown as a pictorial representation of a floor of a building in which the space is located.

The methods and system of the present disclosure can be used with either type of interface to generate a prioritized list of reports 303 as shown, for example, in FIG. 5.

FIGS. 4 and 5 also represent different levels of information, each offering a different context within the building automation system to the user. FIG. 4 provides a summary view 204 of a building 205, “Enterprise High School,” within a building automation system, which the user has selected for viewing from the navigation tree 206. The summary view 204 includes a historical list of alarms 208, including details related to each alarm 210, and a list of spaces 212, including a summary of details of types of equipment 214, and other properties and measurements associated therewith 216. In the embodiment of the user interface 300 of FIG. 4, actionable content 202 is provided to “Run Reports.” In response to user-selection of this content 202, a prioritized list of predefined reporting options is provided in accordance with the embodiments of the present disclosure. Based on the context of user interface 300, system-level reports may be scored higher than device-level reports, depending on other system conditions which be used to weight the relevance scores of the reporting options accordingly.

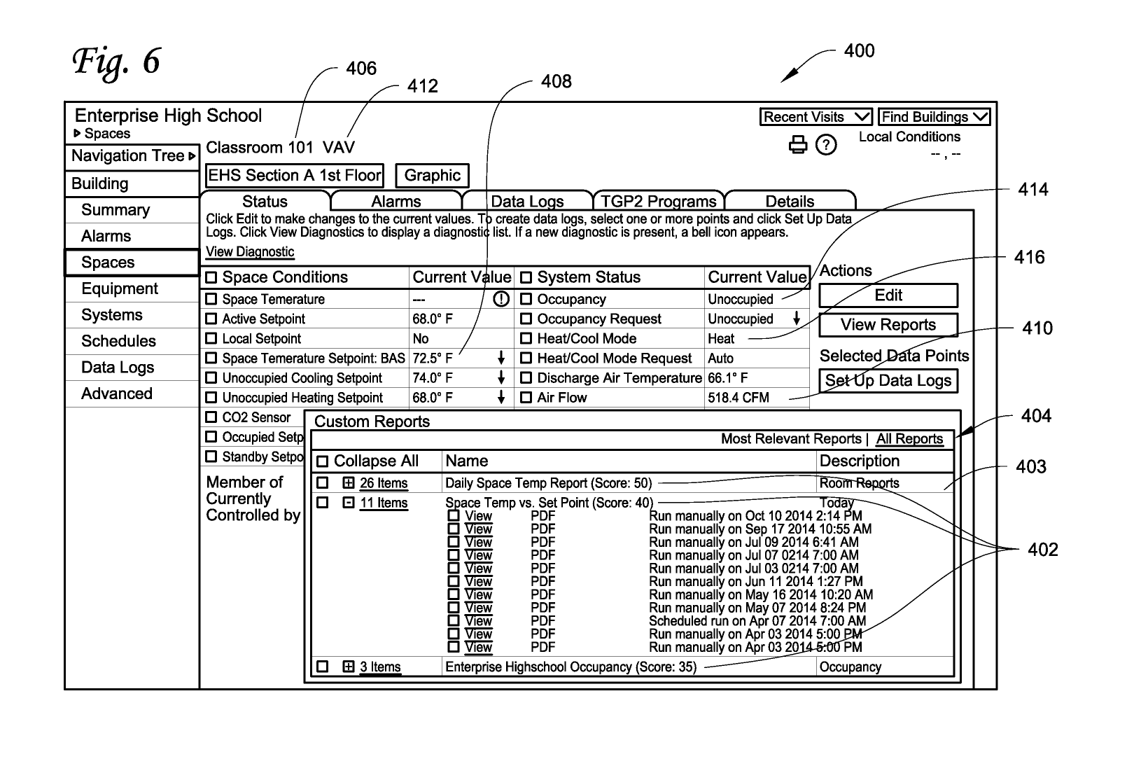

FIG. 6 provides another user interface 400, which presents current information in the form of a standard interface relevant to the same variable air volume unit as that shown in FIG. 5. As illustrated by FIG. 6, the user interface 400 provides contextual information for a particular space or room (“Classroom 101”) 406 within a building. The contextual information includes data such as a space set temperature 408 and air flow measurements 410 associated with a particular piece of equipment, a variable air volume unit 412, controlling the space 406. The contextual information also includes additional properties or modes provided by sensors or devices associated with the space. In particular, an occupancy sensor indicates that the space is not occupied 414, and is being heated 416. Predefined reporting options are ranked based on this contextual information in accordance with embodiments of the present disclosure. For example, based on the context related to user interface 400, the most relevant reporting options are shown in ranked order 402 from most to least relevant as a Daily Space Temperature Report, a Space Temperature vs Set Point Report, and an Occupancy Report. As can be seen, a collapsible and expandable tree 403 is provided within a pop-up window, from which the user can select from a number of reports that have already been run under each of the three reporting options.

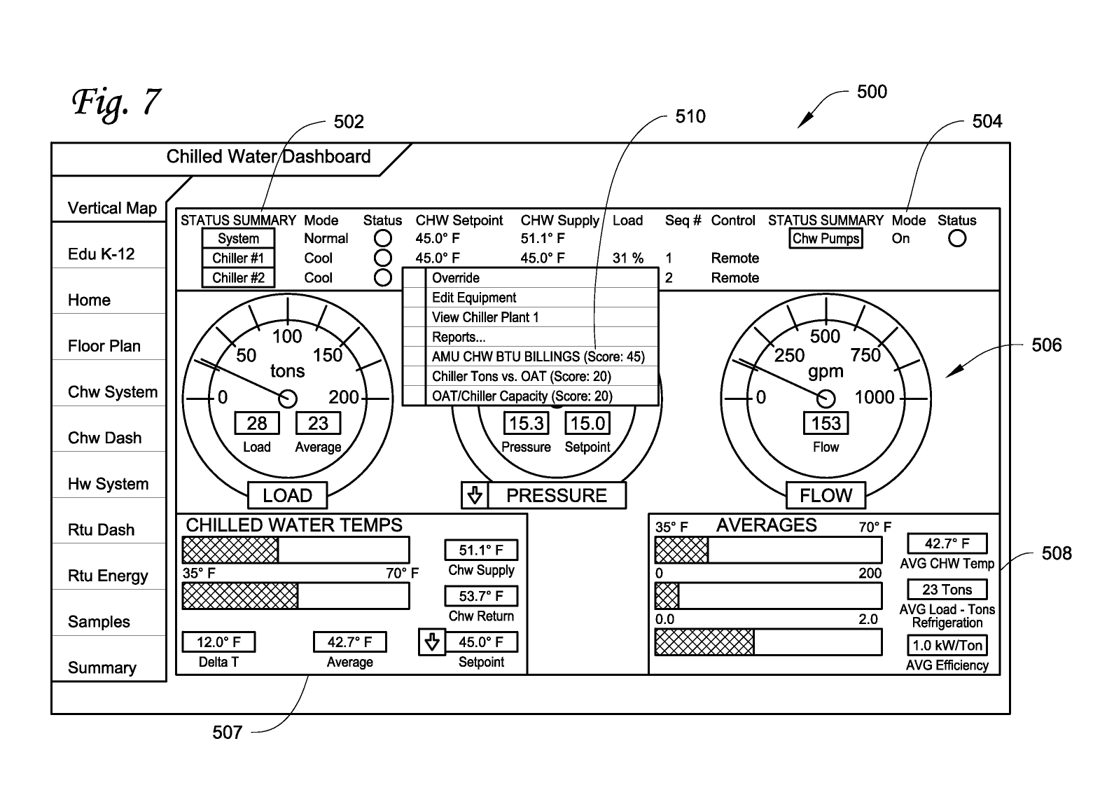

FIG. 7 provides another user interface 500, which presents current information in the form of a customized graphical interface to provide a chilled water dashboard. As illustrated by FIG. 7, the user interface 500 provides contextual information in the form of a summary of the status 502 of chillers in a building automation system. The contextual information includes data properties such as a mode 504 (on) of chilled water pumps, load, pressure and flow measurements 506 represented as analog gauges, chilled water temperature data 507 and average temperature, load, and efficiency measurements 508. Predefined reporting options are ranked based on this contextual information in accordance with embodiments of the present disclosure. For example, based on the context related to user interface 500, the most relevant (three) reporting options, a Chilled Water BTU Billings report, Chiller Tons vs Outside Air Temperature (OAT) report, and OAT/Chiller Capacity report, are shown in ranked order 510 from most to least relevant within a pop-up window, along with their calculated relevance scores.

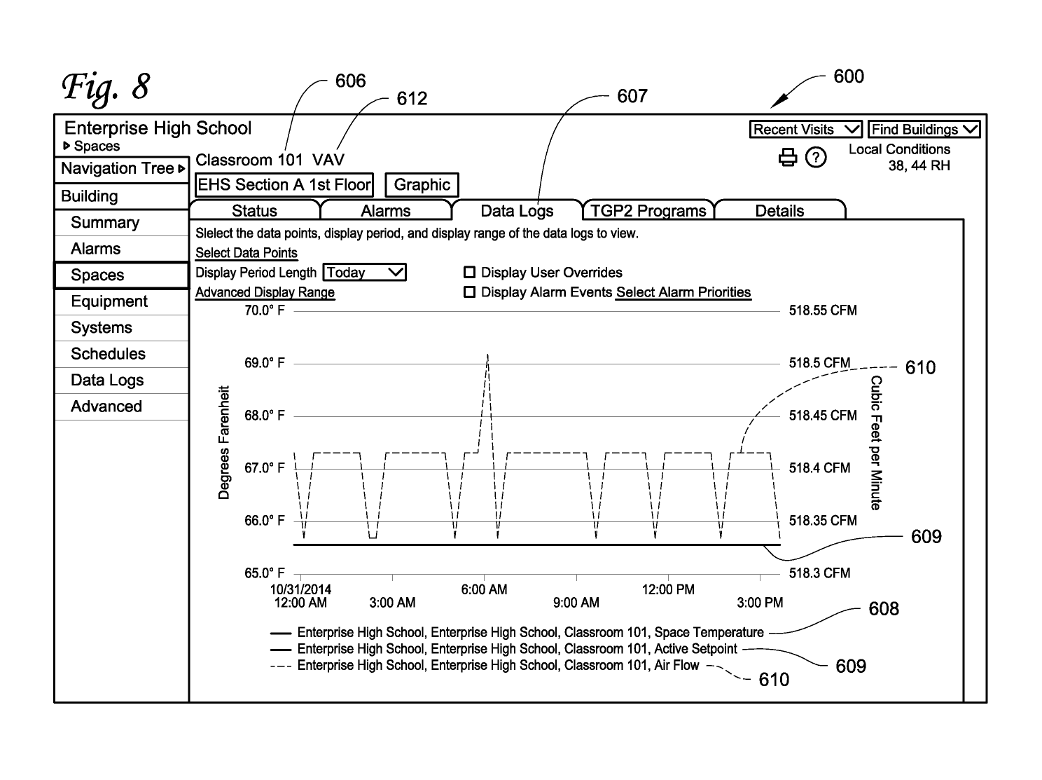

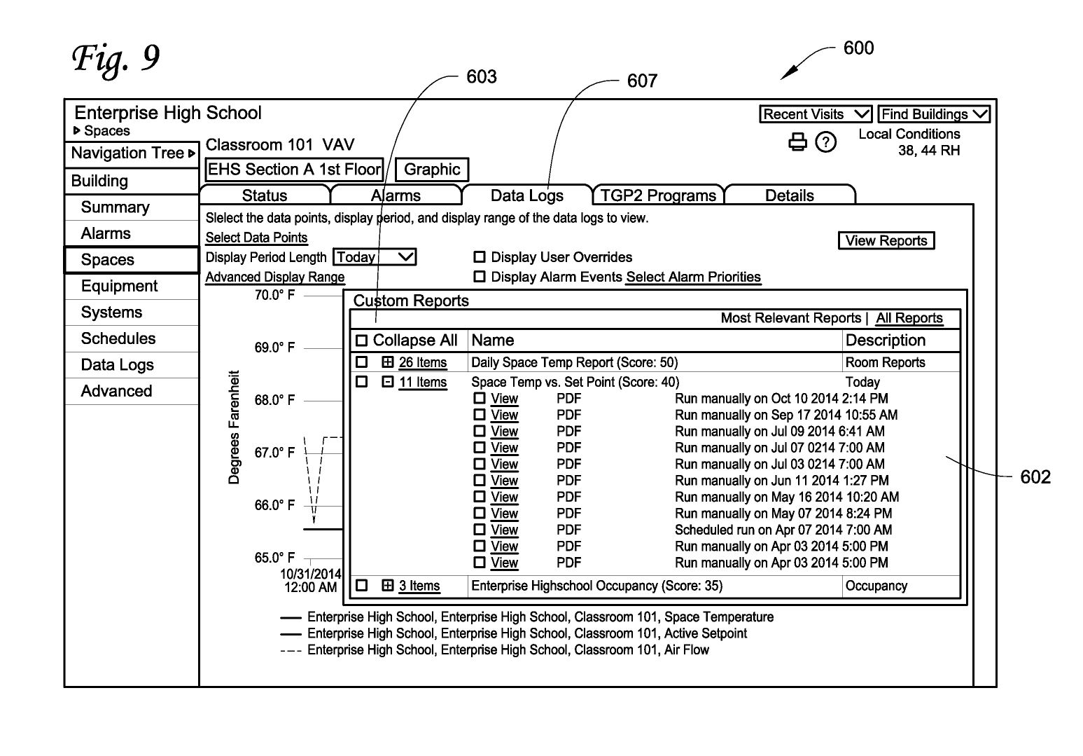

FIG. 8 provides another embodiment of a user interface 600, which provides contextual information for a particular space or room (“Classroom 101”) 606 within a building in another format. The contextual information includes historical data, or data logs 607, in this case, of space temperatures 608, active setpoints 609, and air flow 610 associated with a particular piece of equipment, a variable air volume unit 612, controlling the space 606. Predefined reporting options are ranked based on this contextual information, and may also be based on additional contextual information associated with the user attributes and current system conditions, in accordance with embodiments of the present disclosure. For example, referring to FIG. 9, based on the context related to user interface 600, the most relevant reporting options are shown in ranked order 602 from most to least relevant as a Daily Space Temperature Report, a Space Temperature vs Set Point Report, and an Occupancy Report. As can be seen, a collapsible and expandable tree 603 is provided within a pop-up window, from which the user can select from a number of historical reports that have already been run based on historical data logs 607.

In some embodiments, user interfaces may provide data log views from various equipment user interfaces provided by the building automation system, or directly from equipment summary pages. Additional user interfaces may provide a listing of data logs for an entire building, for example, in the form of a comprehensive list for all equipment within a building automation system.

### ASPECTS

It is noted that any of aspects 1-11 below can be combined with each other in any combination and combined with any of aspects 12-15, or any of aspects 16-20. Any of aspects 12-15 and 16-20 can be combined with each other in any combination.

Aspect 1. A method for providing actionable reporting options to a user of a building automation system via a user interface based on a current context, the method comprising: identifying, by the system, contextual information associated with a user interface in a building automation system; ranking a list of predefined reporting options based on a relevance of each of the predefined reporting options to the contextual information; and presenting the ranked list of predefined reporting options to the user interface.

Aspect 2. The method according to Aspect 1, wherein the ranked list is presented in a pop-up window on the user interface.

Aspect 3. The method according to any of Aspects 1-2, wherein the ranked list is presented in response to user selection of actionable content on the user interface.

Aspect 4. The method according to any of Aspects 1-3, wherein the predefined reporting options are stored in a database associated with the building automation system.

Aspect 5. The method according to any of Aspects 1-4, wherein the predefined reporting options include at least one of customized reporting options defined by a user and standard reporting options provided by the building automation system.

Aspect 6. The method according to any of Aspects 1-5, wherein ranking the list of predefined reporting options includes: scoring one of the predefined reporting options based on a correlation between the contextual information and information included in the corresponding predefined reporting option; assigning a relevance score to each of the predefined reporting options based on the scoring; and ranking the list of predefined reporting options in accordance with the relevance score from a highest to lowest relevance score.

Aspect 7. The method according to any of Aspects 1-6, wherein each predefined reporting option is associated with at least one system property, the scoring including calculating the relevance score for each of the predefined reporting options as a percentage of the system properties included in the predefined reporting option that match the contextual information.

Aspect 8. The method according to Aspect 6, further comprising identifying a current system condition of the building automation system, and weighting, by a predetermined weighting factor, the relevance score for each of the predefined reporting options that includes information associated with the current system condition.

Aspect 9. The method according to Aspect 8, wherein the current system condition includes one of an alarm, a system diagnostic, an equipment diagnostic, a key performance indicator, a predetermined day, and a predetermined range of time.

Aspect 10. The method according to any of Aspects 6-10, further comprising weighting, by a predetermined weighting factor, the relevance score for each of the predefined reporting options based on attributes associated with a user accessing the user interface.

Aspect 11. The method according to any of Aspects 1-10, wherein the contextual information includes at least one of a floor, a space, a building, a system, a piece of equipment, a sensor, a status, a system property, a current system condition, and a user attribute associated with a user accessing the user interface.

Aspect 12. A computer-readable device to store instructions that, when executed by a processing device, cause the processing device to perform operations comprising: identifying contextual information associated with a user interface in a building automation system; ranking a list of predefined reporting options based on a relevance of each of the predefined reporting options to the contextual information; and presenting the ranked list of predefined reporting options to the user interface.

Aspect 13. The computer-readable device according to Aspect 12, wherein the operation of ranking the list of predefined reporting options further includes: scoring one of the predefined reporting options based on a correlation between the contextual information and information included in the corresponding predefined reporting option; assigning a relevance score to each of the predefined reporting options based on the scoring; and ranking the list of predefined reporting options in accordance with the relevance score from a highest to lowest relevance score.

Aspect 14. The computer-readable device according to Aspect 13, the operations further comprising identifying a current system condition of the building automation system, and weighting, by a predetermined weighting factor, the relevance score for each of the predefined reporting options that includes information associated with the current system condition.

Aspect 15. The computer-readable device according to any of Aspects 12-14, wherein the contextual information includes at least one of a floor, a space, a building, a system, a piece of equipment, a sensor, a status, a system property, a current system condition, and a user attribute associated with a user accessing the user interface.

Aspect 16. A building automation system, the system comprising: a server, the server being communicatively coupled to a user device, the user device being configured to display a user interface generated by the server; and a plurality of control devices operably connected to the server; wherein the server is configured to: identify contextual information associated with the user interface in the building automation system; rank a list of predefined reporting options based on a relevance of each of the predefined reporting options to the contextual information; and present the ranked list of predefined reporting options to the user interface.

Aspect 17. The building automation according to Aspect 16, the server further configured to: receive data, including data attributes associated with the data, from the plurality of control devices; and generate the user interface with the contextual information from the data received.

Aspect 18. The building automation system according to any of Aspects 16-17, the server further configured to: score one of the predefined reporting options based on a correlation between the contextual information and information included in the corresponding predefined reporting option; assign a relevance score to each of the predefined reporting options based on the scoring; and rank the list of predefined reporting options in accordance with the relevance score from a highest to lowest relevance score.

Aspect 19. The building automation system according to any of Aspects 16-18, the server further configured to identify a current system condition of the building automation system, and to weight, by a predetermined weighting factor, the relevance score for each of the predefined reporting options that includes information associated with the current system condition.

Aspect 20. The building automation system according to any of Aspects 16-19, further comprising a database, the server further configured to store the predefined reporting options in the database and to retrieve the predefined reporting options from the database for presenting the ranked list to the user interface.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. A method for providing actionable reporting options to a user of a building automation system via a user interface based on a current context, the method comprising:
identifying, by the system, contextual information associated with a user interface in a building automation system;
ranking a list of predefined reporting options based on a relevance of each of the predefined reporting options to the contextual information; and
presenting the ranked list of predefined reporting options to the user interface.

2. The method of claim 1, wherein the ranked list is presented in a pop-up window on the user interface.

3. The method of claim 1, wherein the ranked list is presented in response to user selection of actionable content on the user interface.

4. The method of claim 1, wherein the predefined reporting options are stored in a database associated with the building automation system.

5. The method of claim 1, wherein the predefined reporting options include at least one of customized reporting options defined by a user and standard reporting options provided by the building automation system.

6. The method of claim 1, wherein ranking the list of predefined reporting options includes:
scoring one of the predefined reporting options based on a correlation between the contextual information and information included in the corresponding predefined reporting option;
assigning a relevance score to each of the predefined reporting options based on the scoring; and
ranking the list of predefined reporting options in accordance with the relevance score from a highest to lowest relevance score.

7. The method of claim 1, wherein each predefined reporting option is associated with at least one system property, the scoring including calculating the relevance score for each of the predefined reporting options as a percentage of the system properties included in the predefined reporting option that match the contextual information.

8. The method of claim 6, further comprising:
identifying a current system condition of the building automation system; and
weighting, by a predetermined weighting factor, the relevance score for each of the predefined reporting options that includes the information associated with the current system condition.

9. The method of claim 8, wherein the current system condition includes one of an alarm, a system diagnostic, an equipment diagnostic, a key performance indicator, a predetermined day, and a predetermined range of time.

10. The method of claim 6, further comprising weighting, by a predetermined weighting factor, the relevance score for each of the predefined reporting options based on attributes associated with a user accessing the user interface.

11. The method of claim 1, wherein the contextual information includes at least one of a floor, a space, a building, a system, a piece of equipment, a sensor, a status, a system property, a current system condition, and a user attribute associated with a user accessing the user interface.

12. A computer-readable device to store instructions that, when executed by a processing device, cause the processing device to perform operations comprising:
identifying contextual information associated with a user interface in a building automation system;
ranking a list of predefined reporting options based on a relevance of each of the predefined reporting options to the contextual information; and
presenting the ranked list of predefined reporting options to the user interface.

13. The computer-readable device of claim 12, wherein the operation of ranking the list of predefined reporting options further includes:
scoring one of the predefined reporting options based on a correlation between the contextual information and information included in the corresponding predefined reporting option;
assigning a relevance score to each of the predefined reporting options based on the scoring; and
ranking the list of predefined reporting options in accordance with the relevance score from a highest to lowest relevance score.

14. The computer-readable device of claim 13, the operations further comprising identifying a current system condition of the building automation system, and weighting, by a predetermined weighting factor, the relevance score for each of the predefined reporting options that includes information associated with the current system condition.

15. The computer-readable device of claim 12, wherein the contextual information includes at least one of a floor, a space, a building, a system, a piece of equipment, a sensor, a status, a system property, a current system condition, and a user attribute associated with a user accessing the user interface.

16. A building automation system, the system comprising:
a server, the server being communicatively coupled to a user device, the user device being configured to display a user interface; and
a plurality of control devices operably connected to the server;
wherein the server is configured to:
identify contextual information associated with the user interface in the building automation system;
rank a list of predefined reporting options based on a relevance of each of the predefined reporting options to the contextual information; and
present the ranked list of predefined reporting options to the user interface.

17. The building automation system of claim 16, the server further configured to:
receive data, including data attributes associated with the data, from the plurality of control devices; and
generate the user interface with the contextual information from the data received.

18. The building automation system of claim 16, the server further configured to:
score one of the predefined reporting options based on a correlation between the contextual information and information included in the corresponding predefined reporting option;
assign a relevance score to each of the predefined reporting options based on the scoring; and
rank the list of predefined reporting options in accordance with the relevance score from a highest to lowest relevance score.

19. The building automation system of claim 16, the server further configured to identify a current system condition of the building automation system, and to weight, by a predetermined weighting factor, the relevance score for each of the predefined reporting options that includes information associated with the current system condition.

20. The building automation system of claim 16, further comprising a database, the server further configured to store the predefined reporting options in the database and to retrieve the predefined reporting options from the database for presenting the ranked list to the user interface.
